(19) United States
(12) Patent Application Publication
(10) Pub. No.: US 2010/0314505 A1
(43) Pub. Date: Dec. 16, 2010

(54) DEVICE FOR HOLDING LINES IN AN AIRCRAFT

(75) Inventors: Sandra Deimer, Hamburg (DE); Jan Harder, Hamburg (DE); Thomas Kriebisch, Hamburg (DE); Axel König, Hamburg (DE); Jean-Marie Le Corre, Hamburg (DE); Thomas Mariak, Henstedt-Ulzburg (DE); Arne Wilhelm, Schwiederstorf (DE); Markus Fritz, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: AIRBUS OPERATIONS GMBH, Hamburg (DE)

(21) Appl. No.: 12/745,945

(22) PCT Filed: Dec. 17, 2008
(86) PCT No.: PCT/EP2008/067764

§ 371 Date: Jun. 3, 2010

Related U.S. Application Data
(60) Provisional application No. 61/008,744, filed on Dec. 21, 2007.

(30) Foreign Application Priority Data
Dec. 21, 2007 (DE) 10 2007 062 193.2

(51) Int. Cl. F16L 3/08

(52) U.S. Cl. 248/74.4

(57) ABSTRACT

The invention relates to a device for holding lines in an aircraft that comprising at least one line inlet, at least one line outlet and at least one holding space for holding at least part of a line section extending between the line inlet and the line outlet, wherein the line section has a length that is equal to or greater than the clear distance between the relevant line inlet and line outlet, and wherein the holding space comprising means for separably holding, as well as for shortening or lengthening in a reversibly guided fashion, a line end that protrudes from the line inlet and/or line outlet. Due to the devices according to the invention, lines that are individually cut to length are no longer required for connecting reconfigurable rows of passenger seats because the device according to the invention releases or takes up excess line lengths depending on the position of the rows of passenger seats.

The invention relates to a device for holding lines in an aircraft with at least one line inlet and at least one line outlet.

In order to supply electric components situated in the passenger seat of an aircraft with electricity, data and the like, rows of passenger seats nowadays are frequently connected to one another with cable harnesses. The lengths of these cable harnesses need to be adapted to the distances between the individual rows of passenger seats. However, it is frequently necessary to shift the seat rows in a passenger aircraft relative to one another and to arrange the seat rows in a different configuration, for example, due to seasonal occupancy fluctuations. The changed distances between the seat rows relative to one another also change the required lengths of connecting cables such that cable harnesses of different lengths are nowadays stocked for this purpose. During the reconfiguration of an aircraft cabin, in which the distances of the seat rows relative to one another are changed, it is either necessary to install new cable harnesses or to laboriously remove the existing excess cable lengths from their stowage site or to stow the unneeded excess cable lengths at their stowage site in compliance with the applicable regulations of the aviation authorities. However, structural space for suitable stowage options is frequently unavailable such that the stowage of excess cable lengths in the seats can frequently lead to a violation of the regulations regarding the installation of cables within aircraft. Until now, the excess cable lengths being created were usually also fixed with disposable cable ties such that the release of an additional cable length and the repeated fixing of the remaining excess lengths resulted in a high expenditure of labor. For example, the reconfiguration of a complete cabin section is usually carried out in one night within normal maintenance intervals such that the aforementioned activities are considered highly time-critical. With respect to reconfiguration tasks, it would therefore be desirable if the amount and the extent of the required activities could be reduced to a minimum. These activities would ideally be limited to the steps of unlocking the mechanical seat connection, shifting the seat groups and subsequently mechanically locking the seats in position without having to pay attention to the routing or stowage of the passenger seat connecting cables.

A similar problem arises with the wiring of a row of passenger seats by means of a floor disconnect box (“Floor Disconnect Box,” “FDB”), several of which are frequently distributed over the entire floor area of a passenger cabin in the direction of the longitudinal aircraft axis in modern passenger aircraft. These floor disconnect boxes serve, for example, for producing data links with an entertainment system (“In-Flight-Entertainment,” “IFE”). Each configuration of the passenger cabin requires new cables between the floor disconnect boxes and the rows of passenger seats connected thereto, wherein these cables respectively have an exactly specified length and a special part number. In this case, all connecting cables are nowadays also exchanged during the reconfiguration of the cabin such that costly extra work is required and a large number of cable lengths needs to be stocked.

It is therefore the object of the invention to diminish or entirely eliminate one or more of the aforementioned disadvantages. The object of the invention consists, in particular, of proposing a device, by means of which feeder or connecting cables can be lengthened or shortened on demand in the simplest possible fashion during the reconfiguration of a passenger cabin of an aircraft, namely in such a way that no mechanical retainers—such as, e.g., cable ties and the like—need to be removed or installed and the entire feeder or connecting cable including the device also complies with the applicable aviation regulations.

This object is attained with a device for holding lines in an aircraft that features at least one line inlet, at least one line outlet and at least one holding space for holding at least part of a line section extending between the line inlet and the line outlet, wherein the line section has a length that is equal to or greater than the clear distance between the relevant line inlet and line outlet, and wherein the holding space features means for separably holding, as well as for shortening or lengthening in a reversibly guided fashion, a line end that protrudes from the line inlet and/or line outlet.

The device according to the invention is advantageous in comparison with solutions known from the state of the art. Due to a defined holding space for holding a line segment, it is possible to shorten or to lengthen a line protruding from the line inlet or line outlet in such a way that the length corresponds to the distance between two rows of passenger seats or between a floor disconnect box and a row of passenger seats. In this case, the line section being held is longer than the distance between the line inlet and the line outlet if the currently installed configuration does not require the maximum line length. The holding space not only provides room for holding a line, but also holding means and therefore makes it possible to reversibly shorten or lengthen the protruding line end. In this context, reversible means that no additional elements need to be manually attached to the line section being held and removed again during a readjustment of the device. It suffices to merely pull the line end out of the device or to press the line end back into the device. In order to simplify the operation, one particularly advantageous embodiment features, for example, a slide coating on its surface, wherein the holding space does not necessarily have to have an essentially straight shape, but may also be realized in a bent fashion. The width of the holding space preferably corresponds to double the bending radius of the line. It is furthermore advantageous if the holding space is provided with a rattle-inhibiting and an abrasion-resistant layer.

The proposed solution makes it possible to merely stock one line length for a reconfigurable passenger cabin because different distances between rows of passenger seats or rows of passenger seats and floor disconnect boxes can be individually and quickly changed with the device.

Another advantageous embodiment in the form of an additional development of the device according to the invention features spring-loaded return pulleys in the holding space that make it possible to actively pull the excess line lengths into the holding space by means of a reverse pulley block of sorts. This type of device for holding lines could, for example, modify an established seat-to-seat wiring and be arranged directly on or underneath passenger seats.

Other advantageous additional developments of the device according to the invention are disclosed in the dependent claims.

The invention is described in greater detail below with reference to the figures. Identical objects are identified by the same reference symbols in the figures. In these figures:

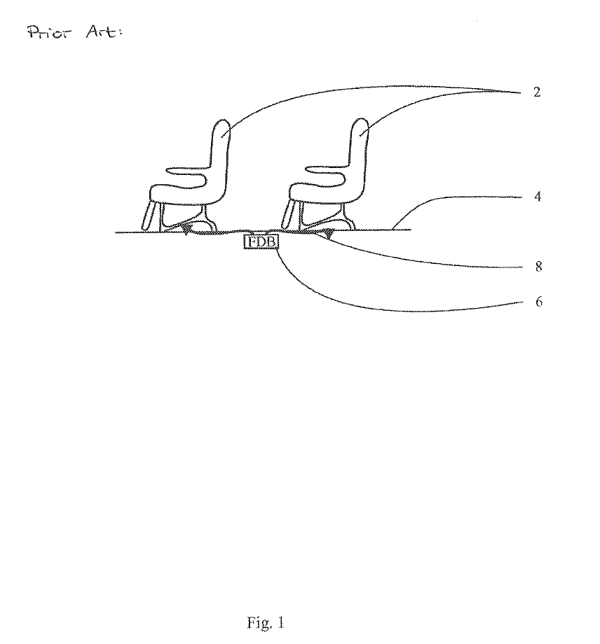

FIG. 1 shows a schematic representation of a floor disconnect box and two rows of passenger seats connected thereto;

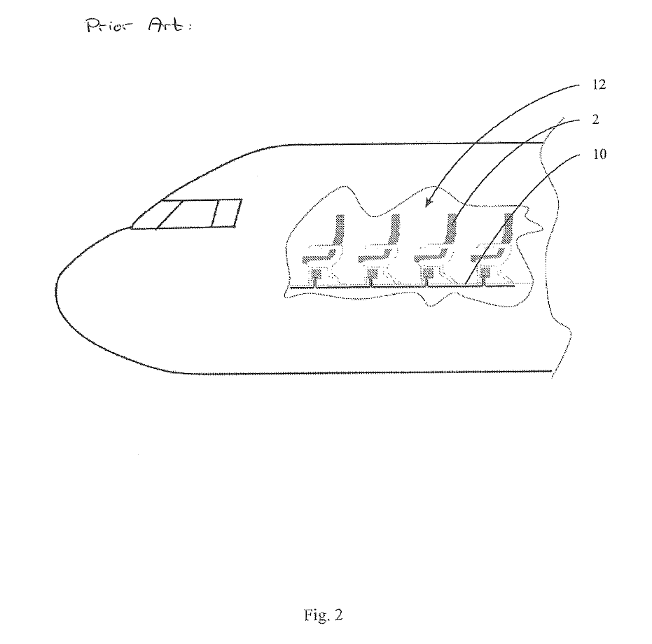

FIG. 2 shows a schematic representation of a seat-to-seat wiring in an aircraft cabin;

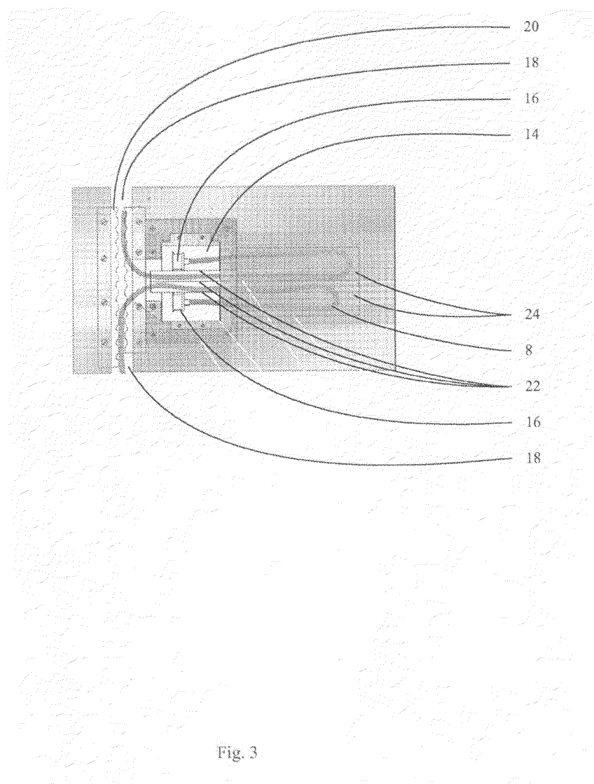

FIG. 3 shows a top view of the first embodiment of the device according to the invention;

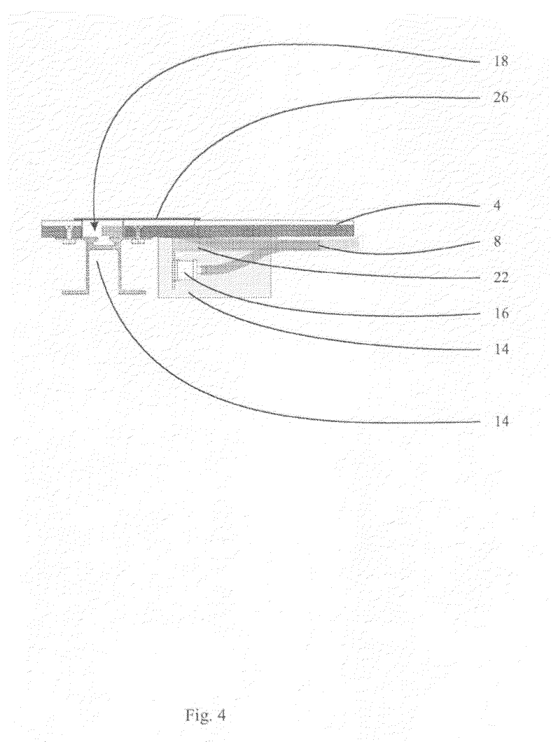

FIG. 4 shows a side view of the first embodiment of the device according to the invention;

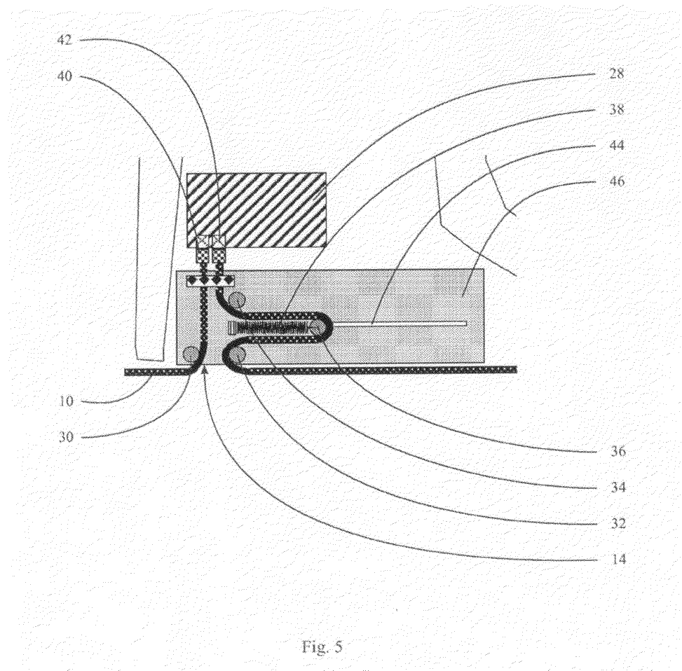

FIG. 5 shows a schematic representation of a second embodiment of the storage device according to the invention;

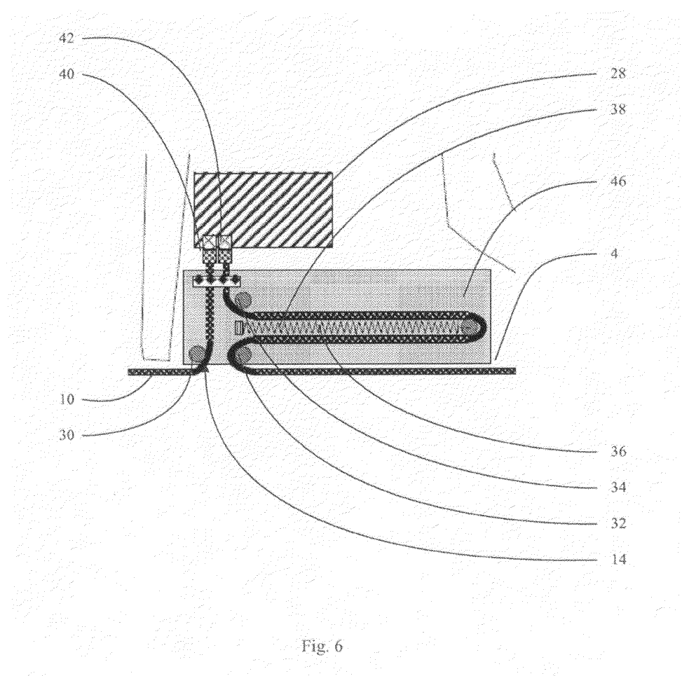

FIG. 6 shows another schematic representation of the second embodiment of the device according to the invention;

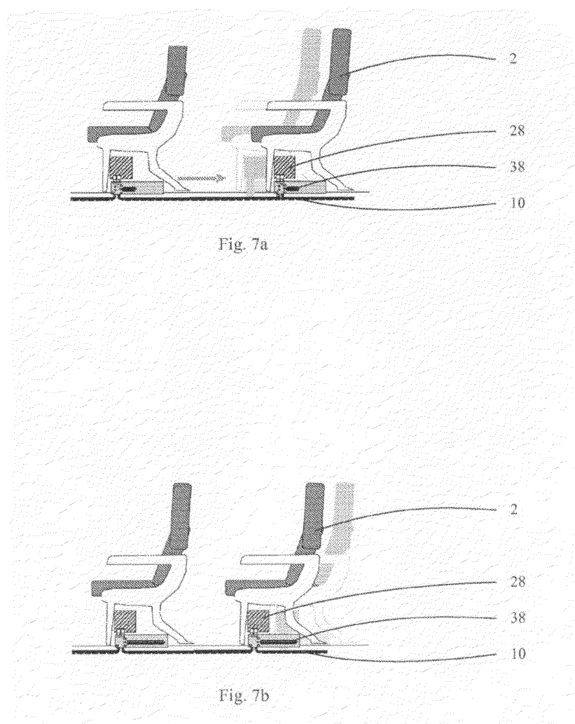

FIG. 7a shows a schematic representation of two rows of passenger seats with the second embodiment of the device according to the invention, wherein the rows of passenger seats are wired together and spaced apart by a greater distance,

FIG. 7b shows a schematic representation of two rows of passenger seats with the second embodiment of the device according to the invention, wherein the rows of passenger seats are wired together and spaced apart by a smaller distance,

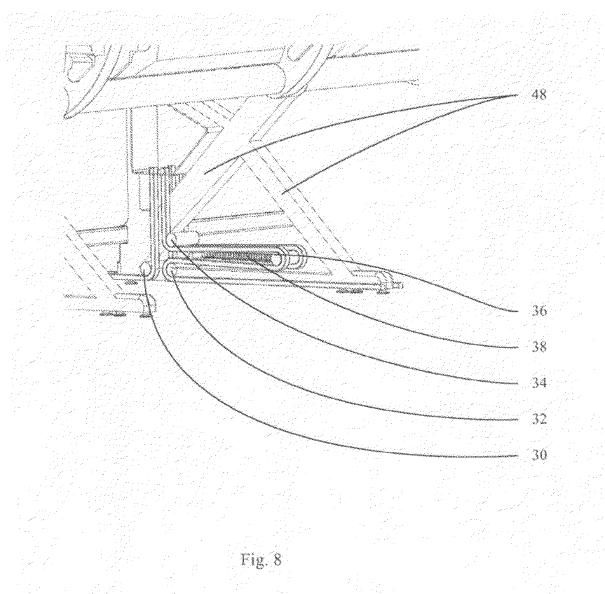

FIG. 8 shows a three-dimensional representation of the second embodiment of the device according to the invention, and

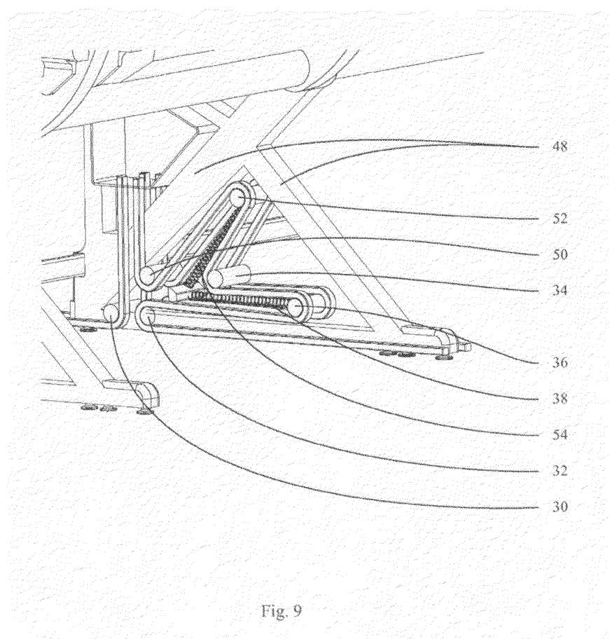

FIG. 9 shows a three-dimensional representation of a variation of the device according to the invention according to the second embodiment.

FIG. 1 shows two rows 2 of passenger seats and a floor disconnect box (“FDB”) 6 situated in the floor 4 according to the state of the art, wherein the rows 2 of passenger seats are connected to the floor disconnect box 6 via lines 8. Floor disconnect boxes 6 are distributed over the floor 4 within the cabin at defined locations. The lines 8 used for producing the connection respectively correspond to the distance between a not-shown connector of a row 2 of passenger seats and the ideally nearest floor disconnect box 6 such that specific lines 8 with exactly defined lengths need to be stocked for each cabin configuration and therefore for all possible lengths of the connections. If the distances between the rows 2 of passenger seats are changed, new lines 8 with a length that is specifically adapted to this configuration are required for connecting the rows 2 of passenger seats to the floor disconnect boxes.

In the seat-to-seat wiring between rows 2 of passenger seats via lines 10 that is illustrated in FIG. 2 and conventionally utilized in the state of the art, the lengths of the lines 10 are constant at least in defined sections of the cabin 12, but also need to be modified after a reconfiguration of the cabin 12.

This problem can be solved with the first embodiment of a device according to the invention according to FIG. 3. This figure shows a floor disconnect box 14 with two terminals 16 for lines 8. The lines 8 lead into the device through line inlets 18 that are situated underneath a seat rail 20 in this case. The lines 8 pushed into the line inlets 18 are bent by approximately 90° in the region of guide walls 22 such that the lines 8 no longer extend parallel to the seat rail 20, but rather in a direction transverse to the seat rail 20. The lines 8 are introduced into the holding spaces 24 through the guide walls 22, wherein the lines are bent once again by 180° in these holding spaces and ultimately run into the terminals 16. The region between one respective holding space 24 and the floor disconnect box 14 is considered to be the line outlet in this case because the lines 8 lead out of the structural space of the device and run into the respective terminals 16.

The holding spaces 24 respectively have dimensions that are specifically adapted to the requirements of the reconfigurable passenger cabin such that either greater or smaller excess cable lengths can be stocked depending on the configuration. The holding spaces 24 to be configured do not have to have a straight shape as illustrated in an exemplary fashion in FIG. 3 for reasons of simplicity. On the contrary, it would also be conceivable that the holding spaces 24 have an overall shape that is bent or curved once or several times and that said holding spaces essentially extend underneath the floor 4 of the cabin. The holding spaces 24 also do not have to lie parallel to the floor 4, i.e., horizontally, but rather may extend in any direction depending on the available structural space.

The sectioned side view according to FIG. 4 elucidates the first embodiment of the device according to the invention and shows the vertical course of one of the two lines 8 shown in FIG. 3 within the device according to the invention. For example, the line 8 extends to the guide walls 22 through the line inlet 18 underneath a cover 26 and then into the holding space 24. The 180° deflection takes place in the holding space 24 such that the line 8 once again extends in the direction of the line inlet 18. The line 8 is additionally bend downward in the vertical direction above the floor disconnect box 14 such that it reaches the downwardly offset terminal 16 in a region referred to as the line outlet in order to produce a connection.

If it becomes necessary to release a section of the excess line length situated in the holding space, it is possible to pull on the line 8 at the line inlet 18 or further outward such that the line 8 moves from the holding space in the direction of the line inlet 18. Vice versa, it is also possible to guide an excess cable length into the holding space 24 by inserting the line 8 in the direction of the line inlet 18. The guide walls 22 and the holding space 24 advantageously feature a slide coating such that the line 8 can slide into the device and out of this device again as easily as possible. If it is not possible to very easily push in or pull out the line 8, movement of the line 8 can be realized by removing the cover 26.

A second embodiment of the device according to the invention is illustrated in FIG. 5. In this figure, the device according to the invention is integrated into a row 2 of passenger seats and situated above the floor 4. In this case, the device according to the invention serves, for example, for connecting an electronics unit 28 that is spaced apart from the floor and arranged on a passenger seat to lines 10 that are respectively connected to the preceding row 2 of passenger seats or the following row 2 of passenger seats.

In this embodiment, the holding and releasing of excess cable lengths takes place actively. For this purpose, the device features several pulleys 30, 32, 34 and 36 that serve as guiding means and for deflection purposes, as well as a spring 38. The line 10 protruding into a line inlet 40 is deflected from a direction extending horizontally referred to the floor 4 into a direction extending vertically referred to the floor 4 by the deflection pulley 30 and connected to a terminal 40 on the electronics unit 28 at this location. For example, this line 10 originates at an electronics unit 28 that is arranged in the preceding row 2 of passenger seats. A second line 10 is connected to a terminal 42 of the electronics unit 28 and initially extends vertically downward in the direction of the floor 4, wherein this line is deflected into a horizontal direction that extends parallel to the floor 4 by the pulley 34, subsequently deflected by 180° by the deflection pulley 36 and ultimately deflected by another 180° in the same plane by the deflection pulley 32. After the last deflection, the line 10 once again extends parallel to the floor 4 and leads out of the device in a line outlet region, namely in the direction of the following row 2 of passenger seats, in which it can be connected to a corresponding terminal 40. The pulley 36 is pressed in the direction of the following row 2 of passenger seats along a guide 44 by means of a spring 38. Due to the multiple deflection of the line 10 around the pulleys 32 to 36, a tractive force that is dependent on the spring force is exerted upon the line end of the line 10 extending rearward to the following row 2 of passenger seats by means of a reverse pulley block of sorts. If this line 10 is connected to the corresponding terminal 40 of the electronics unit 28 of the following row 2 of passenger seats, it is consequently subjected to tension and a possible excess line length therefore automatically moves into a holding space 46 of the device according to the invention.

In the illustration according to FIG. 5, the spring 38 is subjected to relatively high tension such that a corresponding released length of the guide 44 results and the line 10 leading to the following row 2 of passenger seats is relatively long. If the corresponding cabin of the aircraft is reconfigured to a higher seat density such that the distance between the individual rows 2 of passenger seats is reduced, the spring 38 relaxes because a smaller distance between seats leads to a greater excess line length that needs to be held in the holding space 46.

This situation is shown in FIG. 6, in which the spring 38 has its maximum length and the pulley 36 contacts the outermost end of the guide 44. This would represent the configuration with the highest seat density possible and therefore the smallest possible distance that can be realized between two rows 2 of passenger seats.

One particular advantage of the active variation of the device according to the invention featuring the spring 38 and the pulleys 30 to 36 is the minimal adaptation expenditure during a reconfiguration of the cabin. The interaction between devices according to the invention that are distributed over two successive rows 2 of passenger seats is illustrated in FIGS. 7a and 7b. In FIG. 7a, a relatively large distance is adjusted between the two rows 2 of passenger seats. Consequently, the spring 38 is subjected to relatively high tension and a relatively large excess line length in the holding space 46 is removed. A constant tensile force acts upon the outgoing line 10—that is symbolized by the rearwardly directed arrow—of the seat-to-seat wiring 10. This ensures that all excess line lengths are securely stowed and securely held such that no additional cable ties or the like are required. The reconfiguration of the cabin to a layout according to FIG. 7b therefore merely requires the disengagement of a row 2 of passenger seats from the corresponding seat rail positions and the engagement in a forwardly shifted position. This results in an excess cable length that corresponds to the distance between the previous distance between seats in FIG. 7a and the subsequent distance in FIG. 7b and is pulled into the holding space 46 by the spring force. Due to the principle that resembles a pulley block and the multiple deflections, the dimensions of the structural space of the device do not have to correspond to the excess line length to be pulled in and can be realized in a correspondingly compact fashion.

The device according to the invention according to the second embodiment is not limited to the utilization of four pulleys as illustrated three-dimensionally in FIG. 8, but rather can be further modified. FIG. 9 shows a corresponding variation that is also situated within the row 2 of passenger seats, namely underneath the seat surfaces between the chair legs 48. In this case, two additional pulleys 50 and 52 are implemented such that another spring 54 can be incorporated into the device. This additional spring 54 has the effect that altogether greater spring deflections can be realized that also lead to greater excess line lengths to be held. The maximum dimension of the excess cable length to be stowed could, if so required, be additionally increased with other series-connected spring and pulley elements in order to optimally utilize the available structural space. Consequently, an almost maximized adaptability of a seat-to-seat connection 10 can be realized with a variation according to FIG. 9. As an advantageous additional development, the devices shown in FIGS. 8 and 9 also feature a double pulley and spring arrangement for separately routing data lines, power lines or other lines in order to separate aircraft-critical cable bundles from uncritical cable bundles.

In addition, the devices illustrated in FIGS. 8 and 9 can also be covered with a surrounding housing such that merely a closed line module needs to be arranged on a row of passenger seats in order to achieve an easily reconfigurable cabin configuration. The holding space of a device according to the second embodiment corresponds to the maximum structural space occupied by the pulley-spring arrangement that, in the case of a housing cover, corresponds to the structural space of the housing.

In conclusion, it should be mentioned that the device according to the invention can be used in connection with all line types and is not limited to electric lines.

As a supplement, it should be noted that “comprising” does not exclude other elements or steps, and that “an” or “a” does not exclude a plurality. It should furthermore be noted that characteristics or steps that were described with reference to one of the above exemplary embodiments can also be used in combination with other characteristics or steps of other above-described exemplary embodiments. Reference symbols in the claims should not be interpreted in a restrictive sense.

1. A device for holding lines in an aircraft, comprising at least one line inlet, at least one line outlet and at least one holding space for holding at least part of a line section extending between the line inlet and the line outlet, wherein the line section has a length that is equal to or greater than a clear distance between the at least one line inlet and the at least one line outlet, and wherein the holding space includes means for separably holding, as well as for shortening or lengthening in a reversibly guided fashion, a line end that protrudes from at least one of the line inlet or the line outlet.

2. The device of claim 1, wherein the holding space has a width that substantially corresponds to double a bending radius of the line.

3. The device of claim 1, further comprising at least one guide wall for guiding the line into the holding space.

4. The device of claim 3, wherein at least one of the guide wall or the holding space includes a slide coating.

5. The device of claim 1, wherein the device is adapted in such a way that the line is subjected to at least a 180° deflection in the holding space if an excess length needs to be held.

6. The device of claim 1, wherein the device is arranged in the floor of an aircraft cabin and adapted for releasing lines leading to rows of passenger seats.

7. The device of claim 1, further comprising at least one deflection pulley for deflecting and holding the line.

8. The device of claim 7, further comprising two or more deflection pulleys for deflecting and holding the line several times.

9. The device of claim 7, wherein at least one deflection pulley is displaceably arranged in a guide and pressed or pulled toward one end of the guide by means of a spring.

10. The device of claim 7, wherein the device is adapted in such a way that the line is subjected to at least two deflections of about 180°.

11. The device of claim 7 further comprising a housing.

12. The device of claim 1, wherein the device is adapted for holding excess line lengths of the line between a floor disconnect box and a corresponding connection of a row of passenger seats in an aircraft.

13. The device of claim 1, wherein the device is adapted for holding excess line lengths of the line between two corresponding connections of electronics units of two successive rows of passenger seats in an aircraft.
